(19) United States
(12) Patent Application Publication
(10) Pub. No.: US 2019/0051173 A1
(43) Pub. Date: Feb. 14, 2019

(54) METHOD AND APPARATUS FOR VEHICLE CONTROL HAZARD DETECTION

(71) Applicant: Faraday&Future Inc., Gardena, CA (US)

(72) Inventor: Taewook Lucas Kang, Santa Clara, CA (US)

(21) Appl. No.: 15/716,931

(22) Filed: Sep. 27, 2017

Related U.S. Application Data
(60) Provisional application No. 62/400,453, filed on Sep. 27, 2016.

(51) Int. Cl. G08G 1/0967; B60W 30/09; B60W 30/095; G05D 1/00; G05D 1/02

(52) U.S. Cl. CPC G08G 1/096791; B60W 30/09; G05D 2201/0213; G05D 1/0088; G05D 1/0285; B60W 30/0956

(57) ABSTRACT

A system for hazard identification and mitigation in a vehicle is provided. The system may include a hazard signal reception unit configured to receive remote-origin signals indicative of an approaching hazard, such as an oncoming train. The system may be configured to determine an appropriate hazard mitigation action and to implement the hazard mitigation action to reduce potential danger to the vehicle.

### CROSS-REFERENCE TO RELATED APPLICATIONS

This application claims the priority benefit of U.S. Provisional Application No. 62/400,453, filed Sep. 27, 2016, the entirety of which is hereby incorporated by reference.

### TECHNICAL FIELD

The present disclosure relates generally to methods and systems for autonomous and semi-autonomous vehicle control and hazard detection.

### BACKGROUND

Autonomous and semi-autonomous vehicles require perception systems to identify and classify objects in the vehicle's vicinity. Prediction of movement of objects may also be required, particularly with respect to objects that represent a hazard to the vehicle. Some hazards may be difficult to detect. Train track crossings may represent a particularly difficult class of problem, as train crossings are not uniform, comprising different combinations of lights, bells, and barrier arms in different configurations. Due to drawbacks in conventional perception systems to accurately identify the approach of a train, alternative methods may be desired.

### SUMMARY

In some implementations, an in-vehicle control system detecting and mitigating hazards is provided. The system may include an actuator system configured to provide control of the vehicle, a controller configured to control the actuator system, a hazard detection unit configured to receive a hazard signal and generate hazard information indicating a hazard based on the hazard signal, and a computer system. The hazard detection unit is configured to transmit the hazard information indicating the hazard to the computer system. The computer system is configured to determine a hazard mitigation action in response to the hazard information, and transmit a control signal to the controller to cause the actuator system to perform the hazard mitigation action. The hazard may include a train, such as an approaching or oncoming train, and the hazard signal is received from at least one of a train information database, the train, or a switch system associated with a railroad crossing. The computer system may be further configured to determine whether a current route of the vehicle will intersect with a current route of the train and to determine the hazard mitigation action in response to the determination whether the current route of the vehicle will intersect with the current route of the train.

In some implementations, a method of hazard detection and mitigation performed by systems of a vehicle is provided. The systems include an actuator system providing control of the vehicle, a controller configured to control the actuator system, a hazard detection unit and a computer system comprising at least one physical processor. The method comprises determining, by the hazard detection unit, hazard information indicating a hazard based on a received hazard signal, transmitting, by the hazard detection unit, the hazard information indicating the hazard to the computer system, determining, by the computer system, a hazard mitigation action in response to the hazard information, and transmitting, by the computer system, a control signal to the controller to cause the actuator system to perform the hazard mitigation action. The hazard may include a train, such as an approaching or oncoming train, and the hazard signal is received from at least one of a train information database, the train, or a switch system associated with a railroad crossing. The computer system may be further configured to determine whether a current route of the vehicle will intersect with a current route of the train and to determine the hazard mitigation action in response to the determination whether the current route of the vehicle will intersect with the current route of the train.

In some implementations, a method of hazard detection and mitigation performed by systems of a vehicle is provided. The systems include an actuator system providing control of the vehicle, a controller configured to control the actuator system, and a computer system comprising at least one physical processor. The method comprises receiving a wireless signal indicating a hazard, determining, by the computer system, a hazard mitigation action in response to the hazard information, and transmitting, by the computer system, a control signal to the controller to cause the actuator system to perform the hazard mitigation action. The hazard may include a train, such as an approaching or oncoming train, and the hazard signal is received from at least one of a train information database, the train, or a switch system associated with a railroad crossing. The computer system may be further configured to determine whether a current route of the vehicle will intersect with a current route of the train and to determine the hazard mitigation action in response to the determination whether the current route of the vehicle will intersect with the current route of the train.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a graphical representation illustrating a vehicle.

FIG. 2 is a schematic view of an exemplary control system layout of a vehicle.

FIG. 3 is a vehicle schematic view illustrating exemplary hazard detection unit locations.

FIG. 4 is a flow chart depicting steps of an exemplary hazard detection and notification method according to an implementation of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Systems, methods, and apparatuses consistent with the present disclosure may be suitable for hazard detection and mitigation. Autonomous and semi-autonomous vehicles may encounter various hazards on the roadways which are difficult to detect through standard perception systems, for example, because they are either rare or not standardized. One or more hazard detection units may be configured to detect a hazard to the vehicle based on reception of a hazard signal. The system may include a vehicle control system configured to take an appropriate hazard mitigation action in response to the detection of a hazard. Embodiments consistent with the present disclosure provide means for detecting hazards via a hazard detection unit and taking hazard mitigation action to reduce dangers. Hazard detection of hazard signals may include detection via sensors, including, for example, cameras, radar units, LIDAR units, ultrasonic units, microphones and other sensors or devices. Hazard detection may also include receiving a remote-origin wireless signal indicative of a hazard. Hazard signals may include any and all information available to a hazard detection unit from the environment surrounding the vehicle, including image and video data, radar data, LIDAR data, ultrasonic data, audio data, remote-origin wireless signals, and any other information that sensors and devices associated with a hazard detection unit may receive.

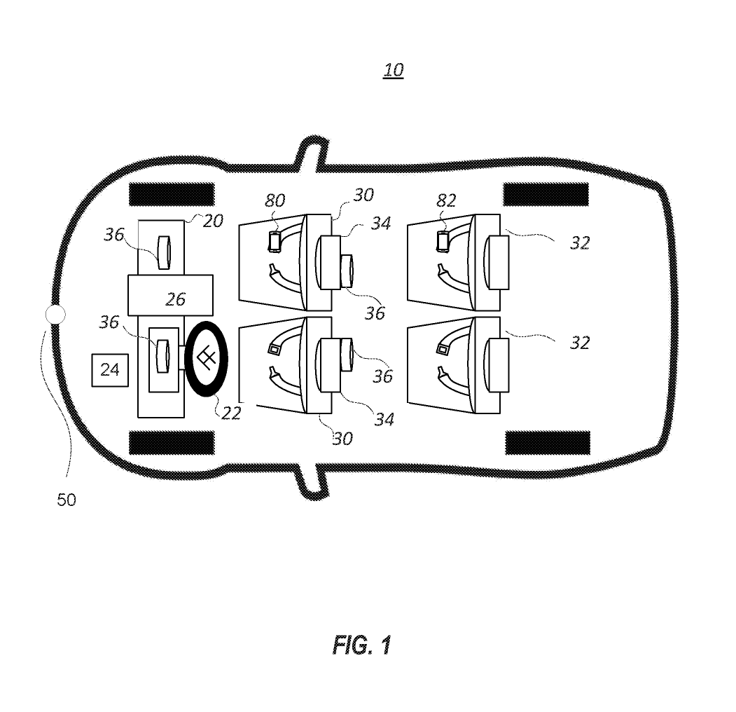

FIG. 1 is a graphical representation illustrating a vehicle 10 for hazard detection and mitigation. Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, semi-autonomous, and/or autonomous.

As illustrated in FIG. 1, vehicle 10 may include a number of components, some of which may be optional. Vehicle 10 may have a dashboard 20 through which a steering wheel 22 and a user interface 26 may project. In one example of an autonomous vehicle, vehicle 10 may not include steering wheel 22. Vehicle 10 may also have one or more front seats 30 and one or more back seats 32 configured to accommodate occupants. Vehicle 10 may further include one or more sensors 36 configured to detect and/or recognize occupants. The positions of the various components of vehicle 10 in FIG. 1 are merely illustrative. For example, sensor 36 may include an infrared sensor disposed on a door next to an occupant, and/or a weight sensor embedded in a seat. Vehicle 10 may also include detector and GNSS (Global Navigation Satellite System (e.g., GPS (Global Positioning System), BeiDou, Galileo) unit 24 disposed at various locations, such as the front of the vehicle. The following description uses GPS as an example, and GNSS unit 24 is referred to as GPS 24. The detector may include an onboard camera.

In some embodiments, user interface 26 may be configured to receive inputs from users or devices and transmit data. For example, user interface 26 may have a display including an LCD, an LED, an OLED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, and/or a tracker ball. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display or broadcast other media, such as maps and lane-specific route navigations.

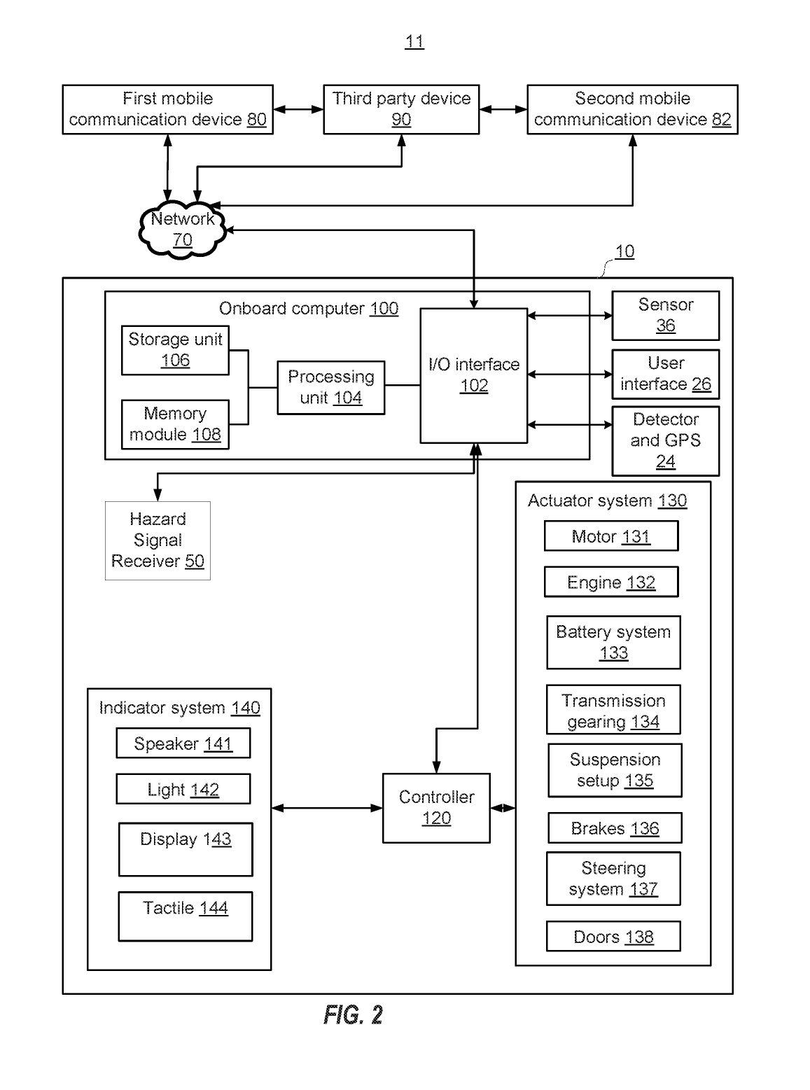

User interface 26 may also be configured to receive user-defined settings. For example, user interface 26 may be configured to receive occupant profiles including, for example, an age, a gender, a driving license status, an advanced driver assistance systems (ADAS) license status, an individual driving habit, a frequent destination, a store reward program membership, and etc. In some embodiments, user interface 26 may include a touch-sensitive surface configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by an onboard computer described below with reference to FIG. 2. The onboard computer may be configured to compare the signal with stored data to determine whether the fingerprint matches recognized occupants. The onboard computer may also be able to connect to the Internet, obtain data from the Internet, and compare the signal with obtained data to identify the occupants. User interface 26 may be configured to include biometric data into a signal, such that the onboard computer may be configured to identify the person who is generating an input. Furthermore, user interface 26 may be configured to store data history accessed by the identified people.

Sensor 36 may include any device configured to generate a signal to be processed to detect and/or recognize occupants of vehicle 10, for example, camera, microphone sound detection sensor, infrared sensor, weight sensor, radar, ultrasonic, LIDAR, or wireless sensor for obtaining identification from occupants' cell phones. In one example, a camera 36 may be positioned on the back of a headrest 34 of a front seat 30 to capture images of an occupant in a back seat 32. In some embodiments, visually captured videos or images of the interior of vehicle 10 by camera 36 may be used in conjunction with an image recognition software, such that the software may distinguish a person from inanimate objects, and may recognize the person based on physical appearances or traits. The image recognition software may include a facial recognition software configured to match a captured occupant with stored profiles to identify the occupant. In some embodiments, more than one sensor may be used in conjunction to detect and/or recognize the occupant(s). For example, sensor 36 may include a camera and a microphone, and captured images and voices may both work as filters to identify the occupant(s) from the stored profiles.

In some embodiments, sensor 36 may include electrophysiological sensors for encephalography-based autonomous driving. For example, fixed sensor 36 may detect electrical activities of brains of the occupant(s) and convert the electrical activities to signals, such that the onboard computer can control the vehicle based on the signals. Sensor 36 may also be detachable and head-mountable, and may detect the electrical activities when worn by the occupant(s).

Detector and GPS 24 may determine in real time the location of vehicle 10 and/or information of the surrounding environment, such as street signs, lane patterns, road marks, road conditions, environment conditions, weather conditions, and traffic conditions, and send the information for processing as described below with reference to FIG. 2.

Vehicle 10 may be in communication with a plurality of mobile communication devices 80, 82. Mobile communication devices 80, 82 may include a number of different structures. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth™ or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be carried by or associated with one or more occupants in vehicle 10. For example, vehicle 10 may be configured to determine the presence of specific people based on a digital signature or other identification information from mobile communication devices 80, 82. For instance, an onboard computer may be configured to relate the digital signature to stored profile data including the person's name and the person's relationship with vehicle 10. The digital signature of mobile communication devices 80, 82 may include a determinative emitted radio frequency (RF) or a global positioning system (GPS) tag. Mobile communication devices 80, 82 may be configured to automatically connect to or be detected by vehicle 10 through local network 70, e.g., Bluetooth™ or WiFi, when positioned within a proximity (e.g., within vehicle 10).

Vehicle 10 may be equipped with one or more hazard detection units 50, located inside or outside the vehicle. Hazard detection units 50 may comprise one or more of: Bluetooth signal receiver, Wi-Fi signal receiver, RFID signal receiver, cellular signal receiver, radar, LIDAR, ultrasonic sensor, microphone, and camera, configured to obtain and/or receive signals indicative of hazards. Some sensors employed by hazard detection units may also be used for autonomous or semi-autonomous driving. For example, a LIDAR, radar, or camera used to assist with autonomous and/or semi-autonomous driving systems may also be used by a hazard detection unit 50. A LIDAR may receive hazard signals in the form of LIDAR data, radar may receive hazard signals in the form of radar data, a camera including one or more 2D or 3D camera may receive hazard signals in the form of image or video data, ultrasonic sensors may receive hazard signals in the form of sonic data, and devices configured to receive wireless signals may receive hazard signals in the form of remote-origin wireless signals.

In some embodiments, hazard detection units 50 may include any type of device capable of receiving a wireless signal, such as an RFID antenna, Bluetooth antenna, a Wi-Fi antenna, a cellular antenna, and others, and circuitry for processing the received wireless signal. Hazard detection units 50 may receive remote-origin signals including one or more of Wi-Fi signals, Bluetooth signals, RFID signals, cellular signals, ZigBee signals, Z-wave signals, and others. Hazard detection units 50 may operate passively to detect any broadcast hazard signals that are available. In some implementations, hazard detection units 50 may operate actively, broadcasting a signal intended to illicit a hazard signal in response. In some implementations, hazard detection units 50 may be configured to receive and/or monitor any signals or data received by other vehicle devices including a transceiver.

FIG. 2 is a block diagram illustrating a system 11 for hazard detection and notification, consistent with exemplary embodiments of the present disclosure. System 11 may include a number of components, some of which may be optional. As illustrated in FIG. 2, system 11 may include vehicle 10, as well as other external devices connected to vehicle 10 through network 70. The external devices may include mobile terminal devices 80, 82, and third party device 90. Vehicle 10 may include a specialized onboard computer 100, a controller 120, an actuator system 130, an indicator system 140, a sensor 36, a user interface 26, a detector and GPS unit 24, one or more hazard detection units 50. Onboard computer 100, actuator system 130, and indicator system 140 may all connect to controller 120. Sensor 36, user interface 26, detector and GPS unit 24, hazard detection units 50 may all connect to onboard computer 100. Onboard computer 100 may comprise, among other things, an I/O interface 102, a physical processing unit 104, a storage unit 106, a memory module 108. The above units of system 11 may be configured to transfer data and send or receive instructions between or among each other. Storage unit 106 and memory module 108 may be non-transitory and computer-readable and store instructions that, when executed by physical processing unit 104, cause vehicle 10 to perform the methods described in this disclosure. The onboard computer 100 may be specialized to perform the methods and steps described below.

I/O interface 102 may also be configured for two-way communication between onboard computer 100 and various components of system 11, such as user interface 26, detector and GPS 24, sensor 36, hazard detection units 50, etc. I/O interface 102 may send and receive operating signals to and from mobile communication devices 80, 82 and third party devices 90. I/O interface 102 may send and receive the data between each of the devices via communication cables, wireless networks, or other communication mediums. For example, mobile communication devices 80, 82 and third party devices 90 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Third party devices 90 may include smart phones, personal computers, laptops, pads, one or more additional vehicles, and/or servers of third parties (e.g., Google Maps™) that provide access to contents and/or stored data (e.g., maps, traffic, store locations, and weather). Third party devices 90 may be accessible to the users through mobile communication devices 80, 82 or directly accessible by onboard computer 100, via I/O interface 102, according to respective authorizations of the user. For example, users may allow onboard computer 100 to receive contents from third party devices by configuring settings of accounts with third party devices 90 or settings of mobile communication devices 80, 82.

Processing unit 104 may be configured to receive signals and process the signals to determine a plurality of conditions of the operation of vehicle 10, for example, through controller 120. Processing unit 104 may also be configured to generate and transmit command signals, via I/O interface 102, in order to actuate the devices in communication.

In some implementations, processing unit 104 may be programmed with computer instructions to implement a navigational system. A navigational system instantiated by processing unit 104 may access maps and/or routing databases stored in storage unit 106, memory module 108, and/or available across a network, for example, the Internet. The navigational system may determine a route of the vehicle to a destination. and, when necessary, may determine a new route to reroute the vehicle to the destination.

Hazard detection units 50 may be configured to determine hazard information based on the received hazard signals. As discussed above, hazard signals may include any and all information indicative of hazards received from the environment surrounding the vehicle. Hazard information obtained from a remote-origin signal may include, in some implementations, simply a retransmission of the remote-origin signal. In some implementations, hazard detection units 50 may perform noise reduction, signal-to-noise boosting, or other techniques to improve the quality of the remote-origin signal. In some embodiments, determined hazard information may include determinations made from hazard signals including sensor data indicating train tracks, level crossings, grade crossings, warning signals, flashing lights, boom gates (e.g., a bar, or pole pivoted to allow the boom to block vehicular access through a controlled point. Typically the tip of a boom gate rises in a vertical arc to a near vertical position). In some embodiments, boom gates are counterweighted so the pole is easily tipped. Such sensor data may include data collected by cameras, radars, LIDARs, ultrasonic sensors, microphones, and any other sensor device included in or associated with hazard detection unit 50. For example, hazard signals received by vehicle 10 at hazard detection unit 50 may indicate that a boom gate is being lowered. In some embodiments, a boom gate may be identified by its markings such as parallel lines, crosses, etc. Cameras and other sensors associated with hazard detection unit 50 may recognize the movement of a boom gate and/or the markings of a boom gate. Hazard detection units 50 may be configured to transmit determined hazard information to onboard computer system 100, via I/O interface 102.

In some implementations, hazard detection units 50 may perform interpretation of the hazard signals. Hazard detection units 50 may analyze the received hazard signal content to determine a hazard that is indicated by the signal, e.g., an approaching train or a raised drawbridge. Hazard detection units 50 may analyze the received hazard signal to determine an origin of the signal. Hazard signals indicative of a hazard may originate from the hazard itself, e.g., a transmitter carried on a train, from a location associated with the hazard, e.g., a switch system associated with a railroad crossing or railroad crossing, from a remote source, e.g., from a train operation center transmitted through cellular or Wi-Fi networks, or from any other suitable point of origin. For example, the train operation center may include a central server having a train information database that stores electronic information about hazards, for example, the location (e.g., real time location), speed, direction, arrival times of all trains associated with a particular railroad. The central server may transmit the electronic information through cellular network, radio network, and/or Wi-Fi networks. The central server may also be connected to the Internet. The vehicle may be connected to the Internet, either directly through cellular network, Wi-Fi, Bluetooth, or other wireless means, or through a mobile device carried by the driver or passenger in the vehicle. Hazard detection units 50 may include connector or adapter to connect the vehicle to the Internet either directly or through a mobile device. In this example, the hazard detection units 50 may obtain hazard signals from the Internet. In some implementations, the remote source may be configured specifically to provide hazard information. In some implementations, hazard detection units 50 may actively query the remote source to determine hazard information. That is, the remote source may be a tracking database from which hazard detection units 50 extract hazard information.

In some implementations, hazard detection units 50 may include one or processors that analyze the received hazard signal to determine extensive information about the indicated hazard. Hazard detection units 50 may determine the existence, location, timing, and other potential hazard information associated with the detected hazard based on the hazard signals. For example, in the case of an approaching train, hazard detection units 50 may analyze the signal to determine how fast the train is moving, how far away the train is, what set of tracks the train is on, estimated times of arrival at one or more nearby railroad crossings, and other information. It should be understood that a received hazard signal, as described, herein, may include data collected by a sensor on vehicle 10 (e.g., a LIDAR, radar) and/or may include a signal produced by a remote source such as a train or crossing. Moreover, a received signal at a hazard detection unit 50 can include, for ease of explanation, an optical signal such as one or more images captured by a camera.

In some embodiments, processing unit 104 may be configured to receive and analyze data received from a hazard detection units 50. In some embodiments, processing unit 104 may perform any or all of the above-described hazard signal interpretation, with hazard detection units 50 acting as a transceiver.

In some embodiments, processing unit 104 may be configured to determine a hazard mitigation action in response to the hazard information received from hazard detection units 50. Hazard mitigation actions may include acceleration, deceleration, deceleration to a stop, rerouting, and any other actions appropriate for avoiding hazard identified by the hazard information.

In some embodiments, processing unit 104 may be configured to determine a hazard mitigation action by first determining whether a current route of the vehicle will intersect with a location of the hazard. A location of the hazard may include individual locations, for example, a railroad crossing, a drawbridge, and/or a continuum of locations, for example, the route of a train. Hazard information received via the remote-origin signal may include, for example, information about a train, it's speed, and the track that it travels on. Based on this information, processing unit 104 may determine a route of the train and may compare the train route to a route of the vehicle. If the route of the train and the route of the vehicle do not intersect, e.g., if the vehicle is traveling near a train track with an approaching train but is not routed to cross the track, then processing unit 104 may determine not to take any hazard mitigation action. Alternatively, if a vehicle route is planned to cross the route of the train, then processing unit 104 may use this information in a determination of whether or not to take hazard mitigation action. In some implementations, processing unit 104 may access a map or other navigational aid to determine whether the routes will cross, where the routes will cross, and where appropriate stopping points may be.

In some implementations, the determined hazard mitigation action may include acceleration. If computer system 100 determines that the vehicle route and the hazard location will intersect, computer system 100 may act to ensure that the vehicle and the hazard are not present at the intersection at the same time. Where a train is traveling on a track that intersects with a vehicle route, computer system 100 may use the hazard information to determine when the train will arrive at the route intersection, i.e., a railroad crossing, and determine to accelerate the vehicle to avoid a collision with the train. Determinations to accelerate the vehicle may be made in keeping with other safety concerns, including speed limits and traffic flow. Accelerating the vehicle based on an approaching train may be selected with an appropriate buffer time. The buffer time may be the time after the vehicle crosses the intersection that the hazard is expected to arrive, for example, 5 seconds, 10 seconds, 30 seconds, or longer.

In some implementations, the determined hazard mitigation action may include decelerating the vehicle. If computer system 100 determines that the vehicle route and the hazard location will intersect, computer system 100 may act to ensure that the vehicle and the hazard are not present at the intersection at the same time. Where a train is traveling on a track that intersects with a vehicle route, computer system 100 may use the hazard information to determine when the train will arrive at the route intersection, i.e., a railroad crossing, and determine to decelerate the vehicle to avoid a collision with the train. Determinations to decelerate the vehicle may be made in keeping with other safety concerns, including speed limits and traffic flow. Decelerating the vehicle based on an approaching train may be selected with an appropriate buffer time. The buffer time may be the time before the vehicle crosses the intersection that the hazard is expected to arrive, for example, 5 seconds, 10 seconds, 30 seconds, or longer. A vehicle may be decelerated as it approaches the hazard intersection to avoid having to stop completely at the hazard intersection. Deceleration of the vehicle may be a preferred option to avoid a collision, for example, to improve fuel economy and/or improve driver satisfaction. Coming to a complete stop and restarting may require more fuel than a more modest deceleration over a longer period of time, and vehicle occupants may find a decelerated vehicle preferable to a stopped vehicle.

In some implementations, the determined hazard mitigation action may include decelerating to a stop. If computer system 100 determines that the vehicle route and the hazard location will intersect, computer system 100 may act to ensure that the vehicle and the hazard are not present at the intersection at the same time. In situations where accelerating or the decelerating the vehicle cannot be performed safely or legally, computer system 100 may determine that decelerating to a stop is an appropriate hazard mitigation action. Determinations to decelerate to a stop may be made in keeping with other safety concerns, including speed limits and traffic flow.

In some implementations, the determined hazard mitigation action may include rerouting the vehicle. If computer system 100 determines that the vehicle route and the hazard location will intersect, computer system 100 may act to ensure that the vehicle and the hazard are not present at the intersection at the same time. Some situations may arise where a vehicle's route must intersect the route of a hazard, but may do so at more than one location. Computer system 100 may determine that a total vehicle trip time may be reduced by rerouting the vehicle such that a new route of the vehicle intersects the route of the hazard at a time when the hazard will not be present. For example, computer system 100 may determine to reroute the vehicle to travel parallel to train tracks and cross them at an alternate location at a time that the train will not be there. In some implementations, computer system 100 may determine to reroute the vehicle to avoid the hazard altogether.

In some embodiments, processing unit 104 may cause user interface 26 and/or indicator system 140 to provide an alert to a driver or other vehicle occupant about a hazard mitigation action being taken. In some implementations, an alert provided to a driver about an approaching hazard may itself be a hazard mitigation action. In some implementations, an alert may include information informing the driver or other vehicle occupant what the hazard mitigation action being taken is and/or what the hazard is. In some implementations, the alert may include a query requesting that a driver or other vehicle occupant select from multiple hazard mitigation options. For example, processing unit 104 may cause user interface 26 to request that the driver or other vehicle occupant select between rerouting the vehicle and stopping the vehicle at an upcoming railroad crossing.

Storage unit 106 and/or memory module 108 may be configured to store one or more computer programs that may be executed by onboard computer 100 to perform functions of system 11. For example, storage unit 106 and/or memory module 108 may be configured to process instructions to carry out the hazard detection methods described herein.

Vehicle 10 can also include a controller 120 connected to the onboard computer 100 and capable of controlling one or more aspects of vehicle operation, such as performing autonomous parking or driving operations using instructions from the onboard computer 100.

In some examples, the controller 120 is connected to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Steering system 137 may include steering wheel 22 described above with reference to FIG. 1. The onboard computer 100 can control, via controller 120, one or more of these actuator systems 130 during vehicle operation; for example, to open or close one or more of the doors of the vehicle using the door actuator system 138, to control the vehicle during autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle or part of user interface 26), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). Onboard computer 100 can control, via controller 120, one or more of these indicator systems 140 to provide indications to a driver or other vehicle occupant of the vehicle of one or more characteristics of the vehicle's surroundings. The characteristics may be determined by sensor 36.

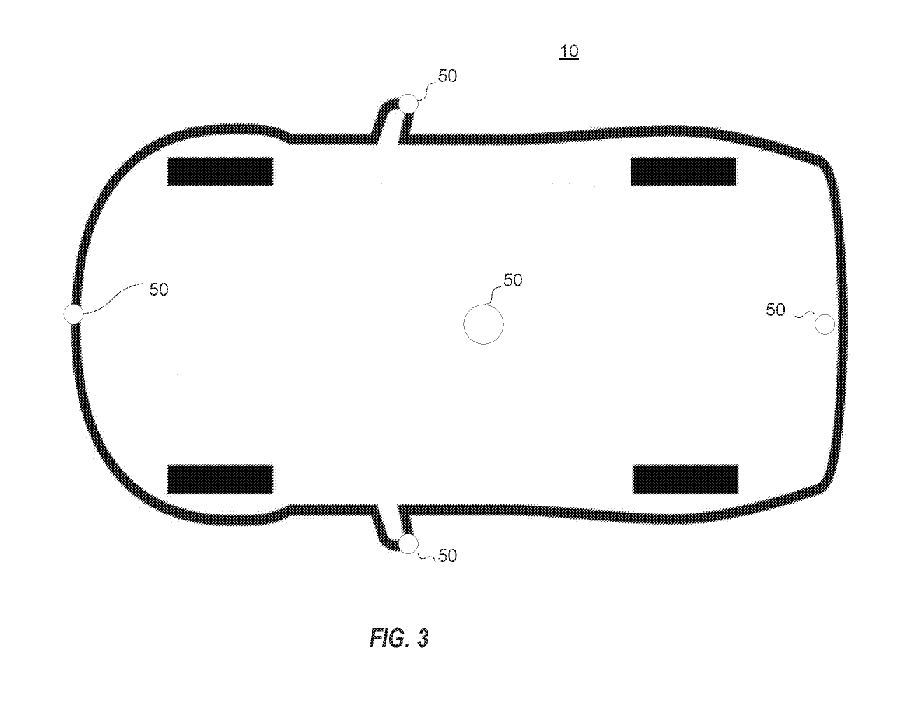

FIG. 3 illustrates an exemplary vehicle schematic with camera locations illustrated. As illustrated in FIG. 3, vehicle 10 may include one or more hazard detection units. FIG. 3 illustrates hazard detection units 50 located at front, rear, and side mirrors of vehicle 10. The illustrated camera locations are exemplary only. Methods and systems consistent with the disclosure may be operated in conjunction with any number of hazard detection units 50 located in any location on the exterior of vehicle 10 or in the interior of vehicle 10.

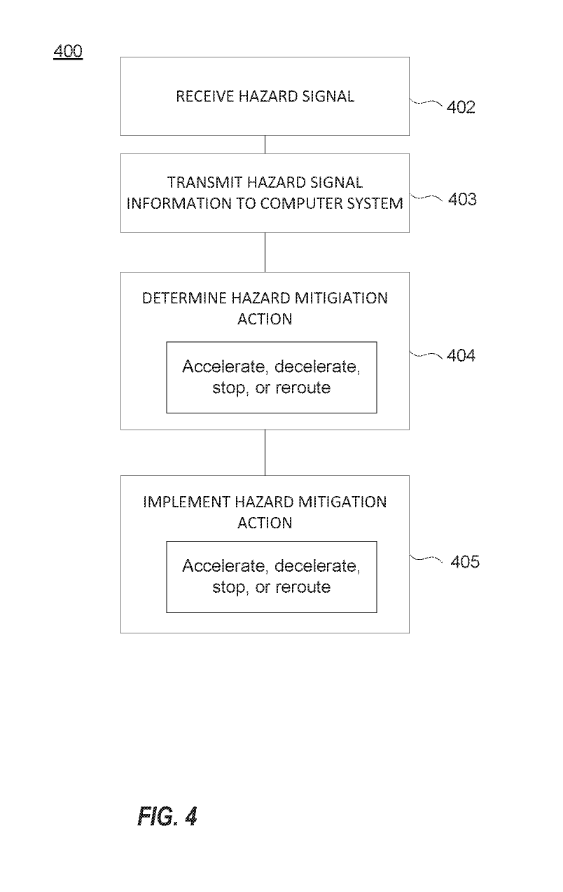

FIG. 4 is a flow chart depicting steps of an exemplary hazard detection and mitigation method 400. Hazard detection and mitigation method may be at least partially carried out by a processing unit 104 of onboard computer 100 and a hazard detection unit 50. As described with respect to FIG. 4, steps hazard detection and mitigation method 400 may be carried out by a processing unit 104 of onboard computer 100. In some implementations, some or all of the steps of hazard detection and mitigation method 400 may be carried out by processing units associated with a cloud computing network.

In an operation 402, hazard detection unit 50 may receive hazard signal indicative of a hazard. The hazard signal may indicate a nearby or remote hazard. As discussed above, hazard detection units 50 may receive any type of wireless remote-origin signal, including Wi-Fi, Bluetooth, RFID, cellular, ZigBee, Z-wave and others. Hazard detection units 50 may also include sensors and obtain hazard signals by those sensors (e.g., radar, LIDAR, etc.).

Hazard signals may vary in their origin. Hazard signals may originate from the hazard itself, e.g., from a moving train. For example, the train may carry a wireless signal transmitter that transmits signals to alert surrounding vehicles. Hazard signals may originate from a device such as a LIDAR or radar. Hazard signals may originate from a location associated with the hazard, e.g., a switch near a rail crossing and/or equipment located at the railroad crossing. Hazard signals may originate from a location remote from both the hazard and the vehicle, e.g., an Internet based system including tracking data of system trains. For example, a train operation center's computer system may have a train information database, such as real time locations of the train. The train operation center may broadcast the information via wireless signals. The hazard detection unit 50 may receive the wireless signals. For another example, the train information database may be connected to the Internet, and the vehicle's computer system may be connected to the Internet and stream real time location information of the trains and/or the trains' schedules. In some implementations, a hazard signal for a train may be triggered by the same switch that triggers crossing signals at a railroad crossing. In some implementations, hazard signals may originate from other vehicles, and be transmitted to a hazard detection unit 50 via a vehicle to vehicle and/or vehicle to cloud communication system.

Hazard signals may vary in an amount of information transmitted. Hazard signals may transmit one or more of an indication of the hazard, a timing of the hazard, a location of the hazard, and other pertinent information. A timing of the hazard may be transmitted with buffer timing indicating a time when it becomes unsafe to approach the hazard. Thus, a train approaching a rail crossing that will arrive in one minute may transmit a timing hazard signal with a 15 or 30 second buffer to alert vehicles not to attempt crossing after the train is 15 or 30 seconds away. In the case where a timing of a hazard is determined by a sensor such as a camera, LIDAR, or radar, logic may be implemented to determine the length of a buffer. Railroad crossing lights and crossing gate activation may be timed to coincide with the buffer timing. An oncoming train, for example, may transmit an indication that it is coming, as well as an indication of when it will arrive at specific railroad crossings, a current location, a speed, and more. Hazard detection units 50 and computer 100 may each be configured to recognize the various information contained in a hazard signal.

In some implementations, hazard detection units 50 may include processors and other components for determining hazard information from the received hazard signal. Hazard information may include information about a potential hazard indicated by the hazard signal, as discussed above. In some implementations, hazard information may include or consist entirely of the hazard signal itself.

In an operation 403, hazard detection unit 50 may transmit hazard information to computer system 100. Hazard information may include a received remote-origin hazard signal. Hazard information may include information derived from one or more sensors. Hazard information may include a noise-reduced version of the remote-origin hazard signal. Hazard information may include information interpreted from the hazard signal, for example, the speed, location, timing, etc., of a hazard. Any or all of the information described above with respect to the received hazard signal may be analyzed by hazard detection unit 50 and transmitted to computer system 100. In some implementations, hazard detection unit 50 may pass the received hazard signal directly to computer system 100 with no analysis, permitting computer system 100 to analyze the hazard signal for information.

In an operation 404, computer system 100 may determine a hazard mitigation action in response to information about a hazard. Hazard mitigation actions may include, but are not limited to, acceleration, deceleration, deceleration to a stop, rerouting, and alerting a driver. To make such a determination, computer system 100 may determine whether a current route of the vehicle will intersect with a current route of the hazard.

In some implementations, the determined hazard mitigation action may include acceleration. As discussed above, acceleration may be appropriate where accelerating the vehicle within safety and legal limits will cause the vehicle to bypass a hazard intersection location before the hazard arrives. For example, where a train is traveling on a track that intersects with a vehicle route, computer system 100 may use the hazard information to determine when the train will arrive at the route intersection, i.e., a railroad crossing, and determine to accelerate the vehicle to avoid a collision with the train. Determinations to accelerate the vehicle may be made in keeping with other safety concerns, including speed limits and traffic flow. Accelerating the vehicle based on an approaching train may be selected with an appropriate buffer time. The buffer time may be the time after the vehicle crosses the intersection that the hazard is expected to arrive, for example, 5 seconds, 10 seconds, 30 seconds, or longer.

In some implementations, the determined hazard mitigation action may include decelerating the vehicle. Deceleration may be appropriate where a modest deceleration within traffic flow and safety limits will cause the vehicle to arrive at the hazard intersection location after the hazard has passed. A choice to decelerate may save fuel and may increase driver satisfaction. Where a train is traveling on a track that intersects with a vehicle route, computer system 100 may use the hazard information to determine when the train will arrive at the route intersection, i.e., a railroad crossing, and determine to decelerate the vehicle to avoid a collision with the train.

In some implementations, the determined hazard mitigation action may include decelerating to a stop. Stopping may be preferred in situations where accelerating or the decelerating the vehicle cannot be performed safely or legally. Computer system 100 may determine that decelerating to a stop is an appropriate hazard mitigation action.

In determining to stop as a hazard mitigation action, computer system 100 may obtain information from vehicle cameras, navigational databases, and other sources to determine an appropriate stopping point to permit the vehicle to remain unharmed by the hazard.

In some implementations, the determined hazard mitigation action may include rerouting the vehicle. In some situations, rerouting a vehicle may permit the route of a vehicle to intersect the route of a hazard at time when the hazard is not present. In other situations, a vehicle may be rerouted to avoid intersection with a route of a hazard altogether. In such situations, rerouting a vehicle may be an appropriate method of hazard mitigation. Computer system 100 may determine that a total vehicle trip time may be reduced, e.g., as compared to stopping and waiting for the hazard to pass, by rerouting the vehicle such that a new route of the vehicle intersects the route of the hazard at a time when the hazard will not be present. For example, computer system 100 may determine to reroute the vehicle to travel parallel to train tracks and cross them at an alternate location at a time that the train will not be there. In some implementations, computer system 100 may determine to reroute the vehicle to avoid the hazard altogether.

In some implementations, the determined hazard mitigation action may include providing an alert to a driver or other vehicle occupant about a hazard mitigation action being taken or an approaching hazard. In some implementations, the alert may include information informing the driver or other vehicle occupant what the hazard mitigation action being taken is and/or what the hazard is. In some implementations, the alert may include a query requesting that a driver or other vehicle occupant select from multiple hazard mitigation options. In some implementations, the alert may include a suggestion of action for a driver to undertake themselves. For example, processing unit 104 may cause user interface 26 to request that the driver reduce vehicle speed so as to arrive at a railroad crossing after a train has passed.

In an operation 405, onboard computer 100 may implement the determined hazard mitigation action. Implementing the hazard mitigation action may include transmitting a signal to controller 120 by onboard computer 100. The signal transmitted to controller 120 may include information about a hazard mitigation action to be taken. Controller 120 may receive the instruction signal from onboard computer 100 and cause actuator system 130 to implement the necessary actions. Implementing the hazard mitigation action may include accessing a navigational system of the vehicle and requesting a rerouting of the vehicle. Implementing the hazard mitigation action may include alerting a driver or other occupant of the vehicle about an approaching hazard and/or providing a suggestion to avoid the hazard.

Hazard detection (including the detection of hazard signals) and hazard mitigation actions are described herein. Many of the exemplary embodiments and illustrative explanations make reference to trains and railroad crossings. The invention described herein is not, however, limited to this single type of hazard. Any road-hazard having a non-standard roadway presentation that a vehicle may encounter may prove difficult to identify by standard vehicle perception systems. Any such hazard may be addressed by systems and methods described herein. Such hazards may include, but are not limited to, drawbridge raisings, road closures, lane closures, debris or other hazards in the road, barricades, and others.

Another aspect of the disclosure is directed to a non-transitory computer-readable storage medium storing instructions which, when executed, cause one or more processors to perform methods, as discussed above. The computer-readable storage medium may include volatile or non-volatile, magnetic, semiconductor, tape, optical, removable, non-removable, or other types of computer-readable storage medium or computer-readable storage devices. For example, the computer-readable storage medium may be the storage unit or the memory module having the computer instructions stored thereon, as disclosed. In some embodiments, the computer-readable storage medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for hazard detection. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. An in-vehicle control system for detecting and mitigating hazards, the system comprising:
an actuator system configured to provide control of the vehicle;
a controller configured to control the actuator system;
a hazard detection unit configured to receive a hazard signal and generate hazard information indicating a hazard based on the hazard signal; and
a computer system,
wherein the hazard detection unit is configured to transmit the hazard information indicating the hazard to the computer system, and
the computer system is configured to determine a hazard mitigation action in response to the hazard information, and transmit a control signal to the controller to cause the actuator system to perform the hazard mitigation action.

2. The system of claim 1, wherein the hazard includes a train and the hazard signal is received from at least one of a train information database, the train, or a switch system associated with a railroad crossing.

3. The system of claim 2, wherein the computer system is further configured to determine whether a current route of the vehicle will intersect with a current route of the train and to determine the hazard mitigation action in response to the determination whether the current route of the vehicle will intersect with the current route of the train.

4. The system of claim 1, wherein the signal includes at least one of a Bluetooth signal, a Wi-Fi signal, an RFID signal, or a cellular signal.

5. The system of claim 1, wherein the hazard detection unit includes at least one of a Bluetooth signal receiver, a Wi-Fi signal receiver, an RFID signal receiver, a cellular signal receiver, a LIDAR unit, a radar unit, a camera, an ultrasonic detector, and a microphone.

6. The system of claim 1, wherein the hazard mitigation action includes alerting a driver of the vehicle.

7. The system of claim 1, wherein the actuator system is configured to perform acceleration in response to the control signal to perform a hazard mitigation action.

8. The system of claim 1, wherein the actuator system is configured to perform deceleration in response to the control signal to perform a hazard mitigation action.

9. The system of claim 1, wherein the actuator system is configured to perform deceleration to a stop in response to the control signal to perform a hazard mitigation action.

10. The system of claim 1, wherein the hazard mitigation action includes rerouting of the vehicle.

11. A method of hazard detection and mitigation performed by systems of a vehicle, the systems including an actuator system providing control of the vehicle, a controller configured to control the actuator system, a hazard detection unit and a computer system, the method comprising:
determining, by the hazard detection unit, hazard information indicating a hazard based on a received hazard signal;
transmitting, by the hazard detection unit, the hazard information indicating the hazard to the computer system;
determining, by the computer system, a hazard mitigation action in response to the hazard information; and
transmitting, by the computer system, a control signal to the controller to cause the actuator system to perform the hazard mitigation action.

12. The method of claim 11, wherein the received hazard signal includes at least one of a Bluetooth signal, Wi-Fi signal, an RFID signal, or a cellular signal.

13. The method of claim 11, wherein the hazard includes a train and the hazard signal is received by the hazard detection unit from at least one of a train information database, an approaching train, or a switch system associated with a railroad crossing.

14. The method of claim 13, further comprising determining whether a current route of the vehicle will intersect with a current route of the train and determining the hazard mitigation action in response to the determination whether the current route of the vehicle will intersect with the current route of the train.

15. The method of claim 11, wherein the hazard detection unit includes at least one of a Bluetooth signal receiver, a Wi-Fi signal receiver, an RFID signal receiver, a cellular signal receiver, a LIDAR unit, a radar unit, a camera, an ultrasonic detector, and a microphone.

16. The method of claim 11, wherein the hazard mitigation action includes alerting a driver of the vehicle.

17. The method of claim 11, wherein transmitting the control signal to the actuator system includes transmitting a control signal instructing the actuator system to perform acceleration as a hazard mitigation action.

18. The method of claim 11, wherein transmitting the control signal to the actuator system includes transmitting a control signal instructing the actuator system to perform deceleration as a hazard mitigation action.

19. The method of claim 11, wherein transmitting the control signal to the actuator system includes transmitting a control signal instructing the actuator system to perform deceleration to a stop as a hazard mitigation action.

20. A method of hazard detection and mitigation performed by systems of a vehicle, the systems including an actuator system providing control of the vehicle, a controller configured to control the actuator system, and a computer system, the method comprising:
receiving a wireless signal indicating a hazard;
determining, by the computer system, a hazard mitigation action in response to the hazard information; and
transmitting, by the computer system, a control signal to the controller to cause the actuator system to perform the hazard mitigation action.
